(19) United States
(12) Patent Application Publication
(10) Pub. No.: US 2008/0273456 A1
(43) Pub. Date: Nov. 6, 2008

(54) Port Trunking Between Switches

(75) Inventors: Jeffrey Paul Messing, Round Rock, TX (US); Jorge Rafael Nogueras, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINE CORPORATION, Armonk, NY (US)

(21) Appl. No.: 12/138,145

(22) Filed: Jun. 12, 2008

Related U.S. Application Data
(63) Continuation of application No. 11/334,668, filed on Jan. 18, 2006.

(51) Int. Cl. H04L 12/24

(52) U.S. Cl. 370/219

(57) ABSTRACT

A computer implemented method, data processing system, and a computer program product are provided for processing packets in switches. A first switch receives a packet from a network that is to be directed to a host. A determination is made as to whether all of the ports connected from the first switch to the host have failed. If all of the ports from the first switch to the host have failed, the packet is sent through a backup port connected to a second switch, which sends the packet to the host.

### BACKGROUND OF THE INVENTION

1. Field of the Invention

The present invention relates generally to port trunking. More specifically, the present invention relates to the use of a backup port for port trunking between switches.

2. Description of the Related Art

In a switched network, as the number of network users increase, the available option for expanding the network is to cascade switches. Port trunking is a concept by which more than one link may be combined thereby increasing the bandwidth between the switches. Port trunking allows multiple physical ports to appear as a single uplinks port. Port trunking is a scalable solution.

Hence, as network traffic increases, the number of link ports may be increased. By having multiple links between a switch and a host, even if a single link fails, the other port trunks are capable of taking care of the data transfer.

With port trunking, a mechanism is provided whereby switches may aggregate several ports together into a link aggregation. This link aggregation behaves as a single port, with a single hardware (media access control (MAC)) address. A packet meant for this aggregation may be sent or received on any of the ports belonging to the aggregation. Furthermore, if any port in the aggregation fails, the switch knows it may use any of the remaining ports in the aggregation to send the packets.

The connection between a switch and a host performing link aggregation is point-to-point, and both endpoints need to agree on the ports that belong to the aggregation. Furthermore, all ports belonging to the same aggregation must be connected to the same switch. That is, it is impossible for a four-port aggregation to be split with two ports in one switch and two ports on another switch. This type of link aggregation means that if the switch with a four-port aggregation fails or if all the ports belonging to that link aggregation on the switch fail, the whole aggregation is lost.

### SUMMARY OF THE INVENTION

The aspects of the present invention provide a computer implemented method, data processing system and computer program product for processing packets in switches. A packet is received in a first switch from a network to be directed to a host. A determination is made to determining if all ports connected from the first switch to the host have failed. If all of the ports have failed, the packet is sent through a backup port connected to a second switch and the second switch sends the packet to the host.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 depicts a block diagram of a data processing system in which aspects of the present invention may be implemented;

FIG. 3 depicts a backup port link aggregation implementation in accordance with an illustrative embodiment of the present invention;

FIG. 4 depicts a functional block diagram of a network switch in accordance with an illustrative embodiment of the present invention;

FIG. 5 illustrates an exemplary operation of a backup port link aggregation when receiving a packet from an outside network in accordance with an illustrative embodiment of the present invention; and

FIG. 6 illustrates an exemplary operation of a backup port link aggregation when receiving a packet from a backup port in accordance with an illustrative embodiment of the present invention.

### DETAILED DESCRIPTION OF THE PREFERRED EMBODIMENT

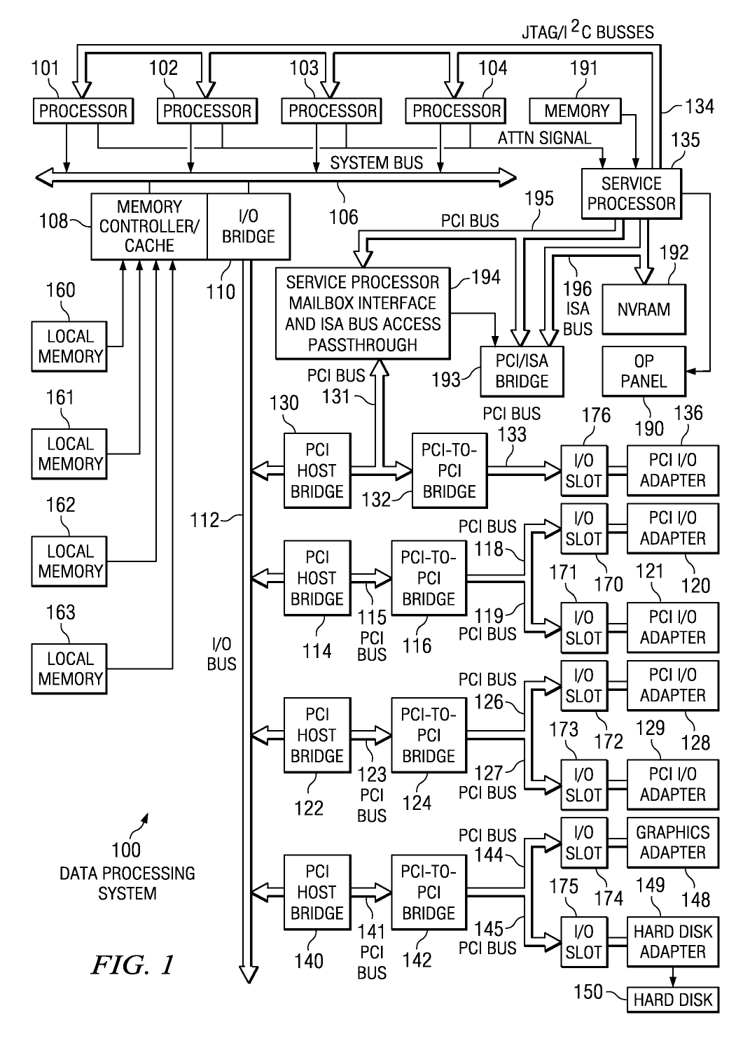

The aspects of the present invention relate to the use of a backup port for port trunking between switches. With reference now to the figures, and in particular with reference to FIG. 1, a block diagram of a data processing system is depicted in which the present invention may be implemented. Data processing system 100 may be a symmetric multiprocessor (SMP) system including a plurality of processors 101, 102, 103, and 104, which connect to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects for a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition 1, a second instance (image) of the AIX operating system may be executing within partition P2, and a Linux or OS/400 operating system may be operating within logical partition P3.

Peripheral component interconnect (PCI) host bridge 114 connected to I/O bus 112 provides an interface to PCI local bus 115. A number of PCI input/output adapters 120-121 connects to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128-129. PCI I/O adapters 128-129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for a PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATS, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

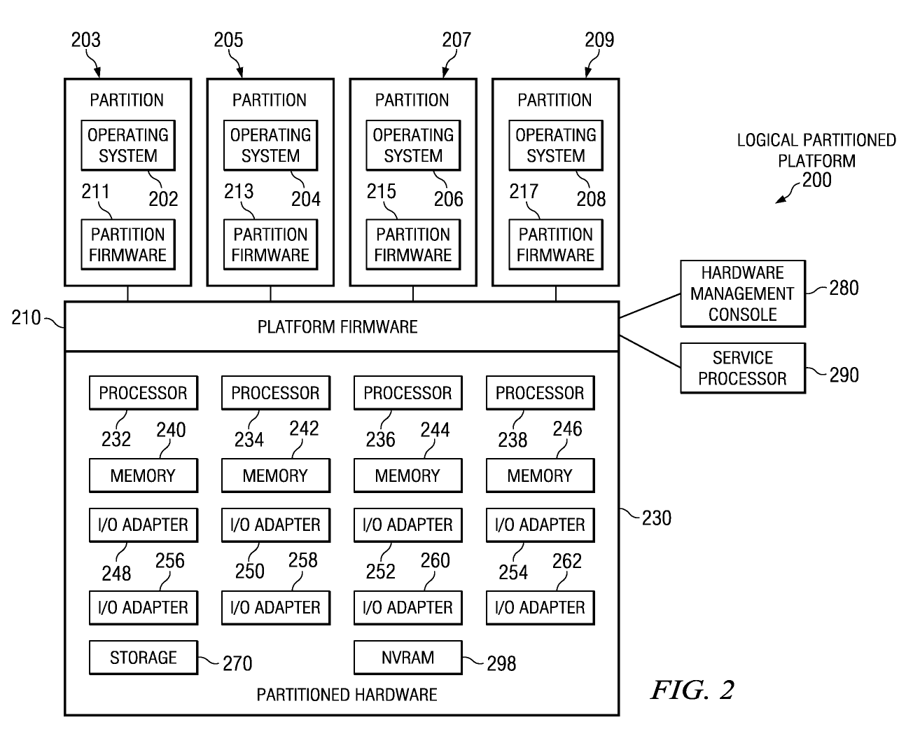

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor. OS/400 is used only as an example in these illustrative embodiments. Of course, other types of operating systems, such as AIX and Linux, may be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

Currently, a connection between a switch and a host performing link aggregation is point-to-point, and both endpoints need to agree on the ports that belong to the aggregation. For example, if a packet with hardware (MAC) address A arrives from a host on port 1 of a switch, the switch “learns” that all packets with hardware (MAC) address A will usually arrive on port 1. The switch returns packets received from an outside network with hardware (MAC) address A to the host using port 1. Only when a packet is received from the host using another port, will the switch change the “learned” behavior to correlate sending packets with hardware (MAC) address A the other port. Thus, at any one time, there is a defined host-to-port-to-switch correlation.

When link aggregation is introduced, the host and switch are able to pass packets on any port that is connected between the specific host and specific switch. Thus, the host and switch no longer care which port is used to send the packet. That is, all ports belonging to the same aggregation must be connected to the same switch. However, there is still a specific host-to-switch correlation.

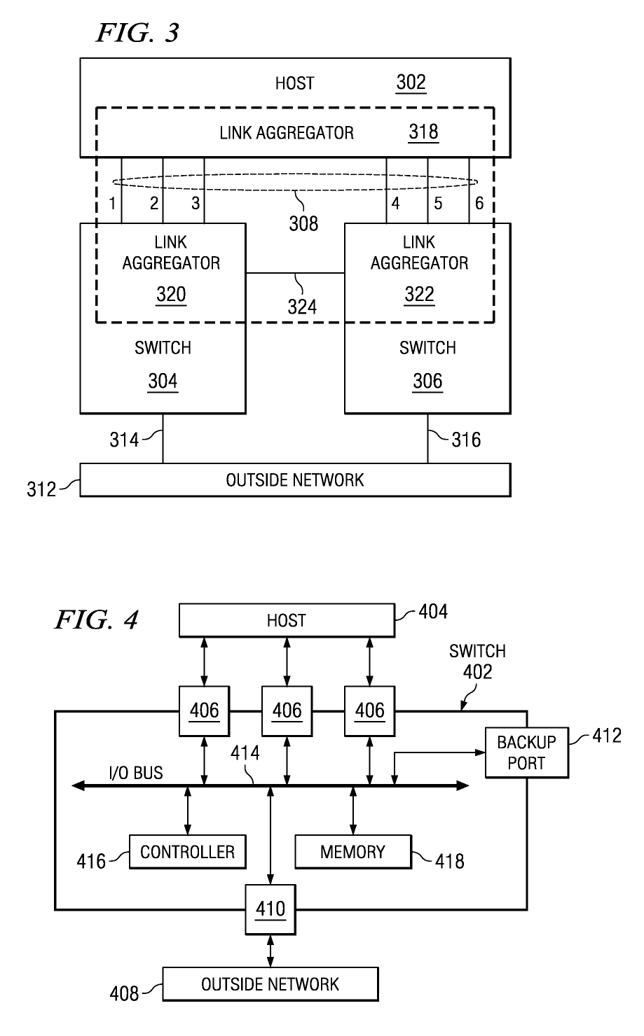

As an aspect of the present invention, backup port link aggregation is used. Backup port link aggregation enables the splitting or enhancing of link aggregation between two or more interconnected switches. FIG. 3 depicts a backup port link aggregation implementation in accordance with an illustrative embodiment of the present invention. In normal operation, host 302 sends a packet out to one of switch 304 or 306 through ports 308. Host 302 may be any host processor, such as host processors 101-104 of FIG. 1. The receiving one of switch 304 or 306 then sends the packet out to outside network 312 through connections 314 or 316. Using backup port link aggregation, which combines the link aggregation of link aggregator 318, link aggregator 320 and link aggregator 322, host 302 is able to send a packet to switch 304 or 306 that is using backup port link aggregation. Using backup port link aggregation, link aggregator 318 of host 302 is configured with one link aggregation that is made up of ports 1, 2, 3, 4, 5, and 6 of ports 308. Link aggregator 320 of switch 304 is configured with ports 1, 2, and 3 of ports 308 as well as backup port 324. Link aggregator 322 of switch 306 is configured with ports 4, 5, and 6 of ports 308 as well as backup port 324. Using the combined link aggregation, the hardware (MAC) address for ports 1, 2, 3, 4, 5, and 6 of ports 308 and backup port 324 is the same, since all of the ports belong to the same link aggregation comprised of link aggregators 318, 320, and 322. Backup port 324 may be implemented using an existing connection between switches. Alternatively, backup port 324 may be implemented using any type of connection that is capable of carrying packets between switch 304 and switch 306.

During normal operation, packets sent from host 302 to outside network 312 may be forwarded out of any of ports 1, 2, 3, 4, 5, or 6 of ports 308 through switches 304 or 306. Any incoming packet to switch 304 from outside network 312 will be forwarded to the host 302 using ports 1, 2, or 3 of ports 308. Any incoming packet to switch 306 from outside network 312 will be forwarded to the host 302 using ports 4, 5, or 6 of ports 308. In the event where ports 1, 2, and 3 of switch 304 fail, any incoming packets from outside network 312 into switch 304 would be forwarded out of backup port 324 to switch 306. Switch 306 would in turn forward the packet to host 302 using ports 4, 5, or 6 of ports 308.

Alternately, in the event where ports 4, 5, and 6 of switch 306 were to fail, any incoming packets from outside network 312 into switch 306 would be forwarded out of backup port 324 to switch 304. Switch 304 would in turn forward the packet to host 302 using ports 1, 2, or 3 of ports 308. Thus, the enhanced link aggregation of switch 304 and 306 is successfully split between switch 304 and 306. Although, the present illustration is shown for two switches, any number of switches may be used. Further, more than one backup port may be implemented using the described method depending on the particular implementation. If there is more than one backup port and when there is a failure of all the main adapters, the switch will send any incoming packets to only one of the backup ports and not multiple backup ports.

FIG. 4 depicts a functional block diagram of a network switch in accordance with an illustrative embodiment of the present invention. Switch 402 may be any switch such as switches 304 and 306 of FIG. 3. Switch 402 is connected to host 404, such as host processors 101-104 of FIG. 1 through ports 406. Further, switch 402 is connected to outside network 408 through connection 410 and has backup port 412 to be connected to another switch. Internally switch 402 has I/O bus 414 that provides an interface for ports 406, connection 410, backup port 412, controller 416, and memory 418. Controller 416 processes incoming packets to determine the routing of the packets. The link aggregation configuration may be stored in memory 418.

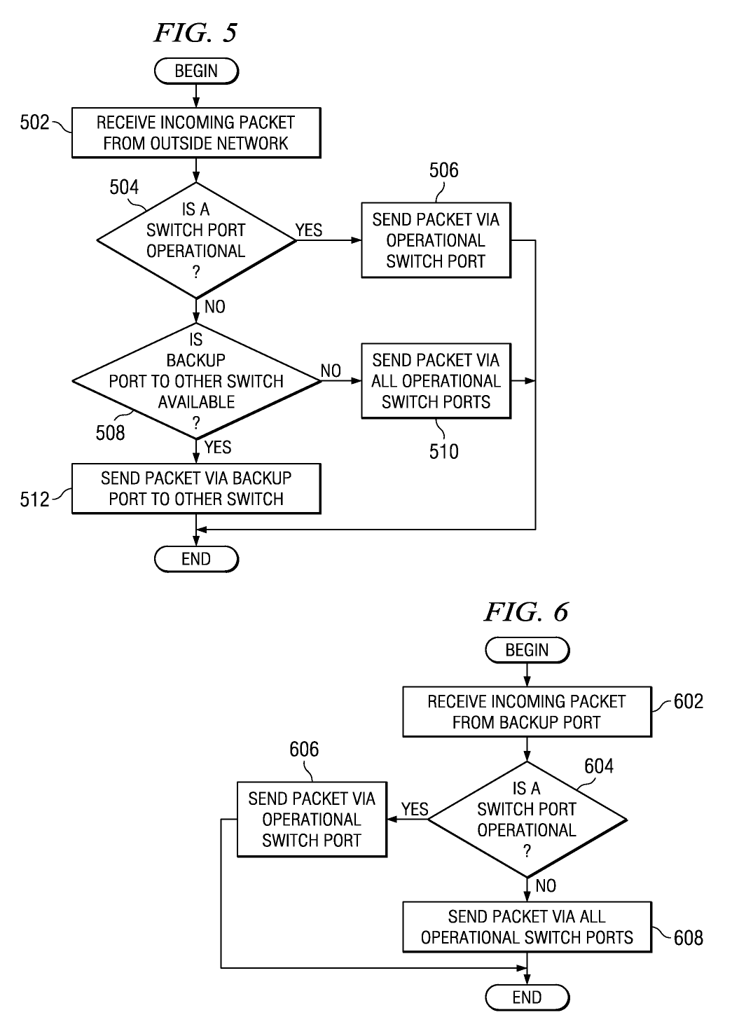

FIG. 5 illustrates an exemplary operation of a backup port link aggregation when receiving a packet from an outside network in accordance with an illustrative embodiment of the present invention. As the operation begins, a packet is received in a switch from an outside network (step 502). The switch determines if there is a port in the link aggregation that is operational (step 504). If a port is operational (step 504), the switch sends the packet to the host via the operational switch port (step 506), with the operation ending thereafter. If at step 504 the ports between the switch and the host have failed, the switch then determines if a backup port between the switch and a second switch is operational (step 508). If the backup port has failed as well (step 508), the packet is sent out to all operational switch ports (step 510), with the operation ending thereafter. If all the primary ports have failed and the backup port has failed, the switch simply “forgets” all the hardware (MAC) addresses that it “learned” for the link aggregation. Thus, when the switch gets a packet for that hardware (MAC) address and all the primary ports and the backup port have failed, the switch does not know where to send the packets anymore, and, thus, the switch sends the packet out of all the operational ports of the switch in the hope that whatever cares about that packet with the specific hardware (MAC) address is out there. If the backup port is available at step 508, the packet is sent to the second switch for processing (step 512), with the operation ending thereafter.

FIG. 6 illustrates an exemplary operation of a backup port link aggregation when receiving a packet from a backup port in accordance with an illustrative embodiment of the present invention. As the operation begins, a packet is received in a second switch from a backup port (step 602). The second switch determines if there is a port in the link aggregation that is operational (step 604). If a port is operational (step 604), the second switch sends the packet to the host via the operational switch port (step 606), with the operation ending thereafter. If all link aggregation ports on the second switch have failed (step 604), the packet is sent out to all operational switch ports of the second switch (step 608), with the operation ending thereafter. Although there is an operational backup port on the second switch, the switch knows that it just received the packet via the backup port and, thus, would not return the packet to the original switch. Although the present illustration is shown for two switches, any number of switches may be used. Furthermore, more than one backup port may be implemented using the described method depending on the particular implementation. Thus, if there is more than one backup port and when there is a failure of all the primary ports of the second switch, the second switch will send any incoming packets to one of the backup ports that the second switch did not receive the packet from initially.

Thus, aspects of the present invention enable the splitting of a link aggregation between two or more switches by introducing the concept of a backup port for link aggregation. When defining link aggregation, an administrator will configure the main ports belonging to the aggregation as well as a backup port that is connected to another switch. The backup port will not be used for link aggregation traffic unless all of the main ports used by the switch have failed. Additionally, any packets received on the backup port that are addressed to the link aggregation itself are sent on the main ports.

Aspects of the present invention remove the switch as a single point of failure while allowing all ports to be used in normal cases. The link aggregation gains performance through the use of many connections rather than the bandwidth limited to a single connection. Implementing link aggregation alone without the use of a backup port, still allows the switch to be a single point of failure.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for processing packets in switches, the computer implemented method comprising:
receiving a packet for a host from a network in a first switch;
determining if all link aggregation ports connected from the first switch to the host have failed; and
if all of the link aggregation ports on the first switch have failed, sending the packet through a backup port connected to a second switch, wherein the second switch sends the packet to the host.

2. The computer implemented method of claim 1, further comprising:
determining if the backup port is available; and
if the backup port is unavailable, sending the packet to all operational switch ports on the first switch.

3. The computer implemented method of claim 1, further comprising:
receiving the packet in the second switch;
determining if all link aggregation ports on the second switch have failed; and
if all of the link aggregation ports on the second switch have failed, sending the packet to all operational switch ports on the second switch.

4. The computer implemented method of claim 1, further comprising:
responsive to operational ports, sending the packet to the host using an operational port.

5. The computer implemented method of claim 1, wherein the ports connected from the first switch to the host and the backup port are configured in a first link aggregation.

6. The computer implemented method of claim 1, wherein the ports connected from the second switch to the host and the backup port are configured in a second link aggregation.

7. The computer implemented method of claim 1, wherein the ports connected from the first switch to the host and the ports connected from the second switch to the host are configured in a host link aggregation.

8. The computer implemented method of claim 3, further comprising:
if all of the link aggregation ports on the second switch have failed, sending the packet through an alternative backup port connected to a third switch, wherein the third switch sends the packet to the host.

9. A data processing system comprising:
a host;
a first switch; and
a second switch, wherein the first switch executes a set of instructions to receive a packet for the host from a network; determine if all link aggregation ports connected from the first switch to the host have failed; and, if all of the link aggregation ports on the first switch have failed, send the packet through a backup port connected to the second switch, wherein the second switch executes a set of instructions to send the packet to the host.

10. The data processing system of claim 9, further including the first switch executing a set of instructions to determine if the backup port is available; and, if the backup port is unavailable, send the packet to all operational switch ports on the first switch.

11. The data processing system of claim 9, further including the second switch executing a set of instructions to receive the packet in the second switch; determine if all link aggregation ports on the second switch have failed; and, if all of the link aggregation ports on the second switch have failed, send the packet to all operational switch ports on the second switch.

12. The data processing system of claim 9, further including the first switch executing a set of instructions to sending the packet to the host using an operational port in response to operational ports.

13. The data processing system of claim 11, further including the second switch executing a set of instructions to, if all of the link aggregation ports on the second switch have failed, send the packet through an alternative backup port connected to a third switch, wherein the third switch sends the packet to the host.

14. A computer program product comprising:
a computer usable medium including computer usable program code for processing packets in switches, the computer program product including:
computer usable program code for receiving a packet for a host from a network in a first switch;
computer usable program code for determining if all link aggregation ports connected from the first switch to the host have failed; and
computer usable program code for, if all of the link aggregation ports on the first switch have failed, sending the packet through a backup port connected to a second switch, wherein the second switch sends the packet to the host.

15. The computer program product of claim 14, further comprising:
computer usable program code for determining if the backup port is available; and
computer usable program code for, if the backup port is unavailable, sending the packet to all operational switch ports on the first switch.

16. The computer program product of claim 14, further comprising:
computer usable program code for receiving the packet in the second switch;
computer usable program code for determining if all link aggregation ports on the second switch have failed; and
computer usable program code for, if all of the link aggregation ports on the second switch have failed, sending the packet to all operational switch ports on the second switch.

17. The computer program product of claim 14, further comprising:
computer usable program code for sending the packet to the host using an operational port in response to operational ports.

18. The computer program product of claim 14, wherein the ports connected from the first switch to the host and the backup port are configured in a first link aggregation.

19. The computer program product of claim 14, wherein the ports connected from the second switch to the host and the backup port are configured in a second link aggregation.

20. The computer program product of claim 16, further comprising:
computer usable program code for if all of the link aggregation ports on the second switch have failed, sending the packet through an alternative backup port connected to a third switch, wherein the third switch sends the packet to the host.
